(19) United States
(12) Patent Application Publication
(10) Pub. No.: US 2005/0233803 A1
(43) Pub. Date: Oct. 20, 2005

(54) Multi-player gaming method and system with side betting option among players

(75) Inventor: Arden Yang, Rosemead, CA (US)

Correspondence Address: DARBY & DARBY P.C., P. O. BOX 5257, NEW YORK, NY, 10150-5257, US

(73) Assignee: ASTRO CORP., San-Chung City (TW)

(21) Appl. No.: 11/036,524

(22) Filed: Jan. 14, 2005

(30) Foreign Application Priority Data
Mar. 30, 2004 (TW) 093108704

(51) Int. Cl. G06F 17/00

(52) U.S. Cl. 463/25

(57) ABSTRACT

A multi-player gaming system includes a plurality of player terminals adapted for operation by game players, respectively, and a host terminal connected to the player terminals and operable so as to enable the game players to play a wagering game therewith. The host terminal is configured to allow the game player of each of the player terminals to place a main bet for the wagering game with the host terminal, and an optional side bet for the wagering game with the game players of other ones of the player terminals. Based on an outcome of the wagering game, the host terminal is configured to settle the main bets placed with the host terminal according to predetermined first winning criteria, and to settle the side bets among the game players of the player terminals who placed a respective side bet according to predetermined second winning criteria.

### CROSS-REFERENCE TO RELATED APPLICATION

This application claims priority of Taiwanese application No. 093108704, filed on Mar. 30, 3004.

### BACKGROUND OF THE INVENTION

1. Field of the Invention

The invention relates to a multi-player gaming method and system, more particularly to a multi-player gaming method and system with side betting option among players.

2. Description of the Related Art

Referring to FIG. 1, a conventional multi-player gaming system 1 is shown to include a plurality of player terminals 11 to 15, each of which is to be operated by a game player, and a host terminal 10 connected to the player terminals 11 to 15 and operable so as to enable the game players to play a wagering game therewith. The wagering game can be a racing game, such as a horse racing game, or a casino game, such as a roulette game or a poker game.

In the conventional multi-player gaming system 1, while it is possible for game players to place a bet for the wagering game with the host terminal 10 through the respective player terminal 11 to 15, the gaming system 1 does not make it possible for the game players to bet among themselves. In other words, in the gaming system 1, several game players compete against the host terminal 10 and are unable to bet on the outcome of the wagering game among themselves. As a result, game players who lost against the gaming system 1 are likely to question the fairness of the gaming system 1 and easily lose interest in playing with the gaming system 1.

### SUMMARY OF THE INVENTION

Therefore, the object of the present invention is to provide a multi-player gaming method and system with side betting option among players to help sustain player interest and excitement.

According to one aspect of the present invention, there is provided a multi-player gaming method to be implemented using a gaming system that includes a plurality of player terminals, each of which is to be operated by a game player, and a host terminal connected to the player terminals and operable so as to enable the game players to play a wagering game therewith. The multi-player gaming method comprises the steps of:

a) configuring the host terminal to allow the game player of each of the player terminals to place a main bet for the wagering game with the host terminal, and an optional side bet for the wagering game with the game players of the other player terminals; and

b) based on an outcome of the wagering game, configuring the host terminal to settle the main bets placed with the host terminal according to predetermined first winning criteria, and to settle the side bets among the game players of the player terminals who placed a respective side bet according to predetermined second winning criteria.

According to another aspect of the present invention, there is provided a multi-player gaming system that comprises a plurality of player terminals and a host terminal. The player terminals are adapted for operation by game players, respectively. The host terminal is connected to the player terminals and is operable so as to enable the game players to play a wagering game therewith. The host terminal is configured to allow the game player of each of the player terminals to place a main bet for the wagering game with the host terminal, and an optional side bet for the wagering game with the game players of other ones of the player terminals. Based on an outcome of the wagering game, the host terminal is configured to settle the main bets placed with the host terminal according to predetermined first winning criteria, and to settle the side bets among the game players of the player terminals whoplaced the respective side bet according to predetermined second winning criteria.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional multi-player gaming system;

FIG. 2 is a flowchart to illustrate a preferred embodiment of a multi-player gaming method according to the present invention; and

FIG. 3 is a perspective view to illustrate a preferred embodiment of a multi-player gaming system according to the present invention.

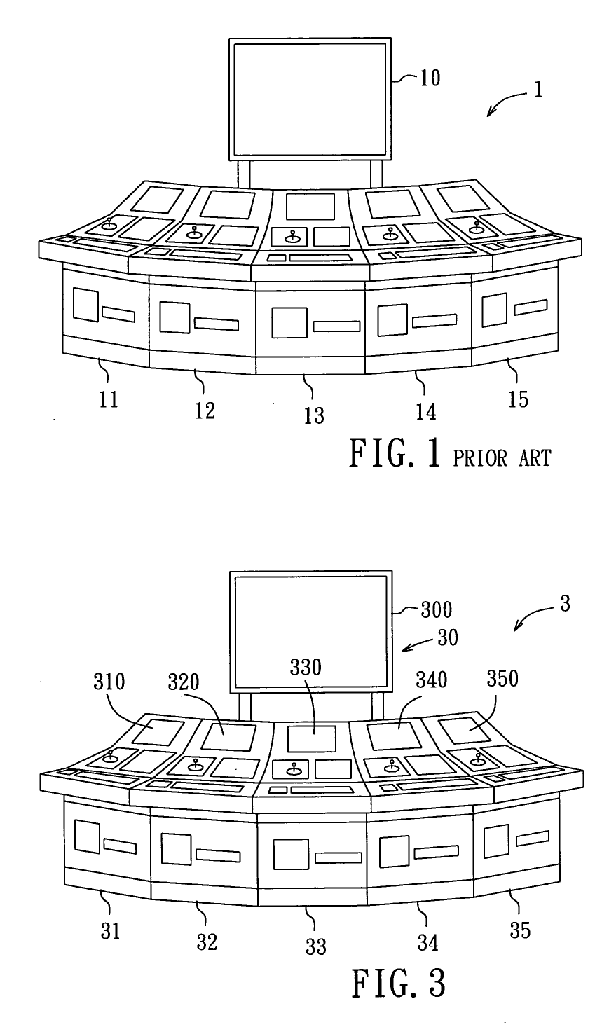

### DETAILED DESCRIPTION OF THE PREFERRED EMBODIMENT

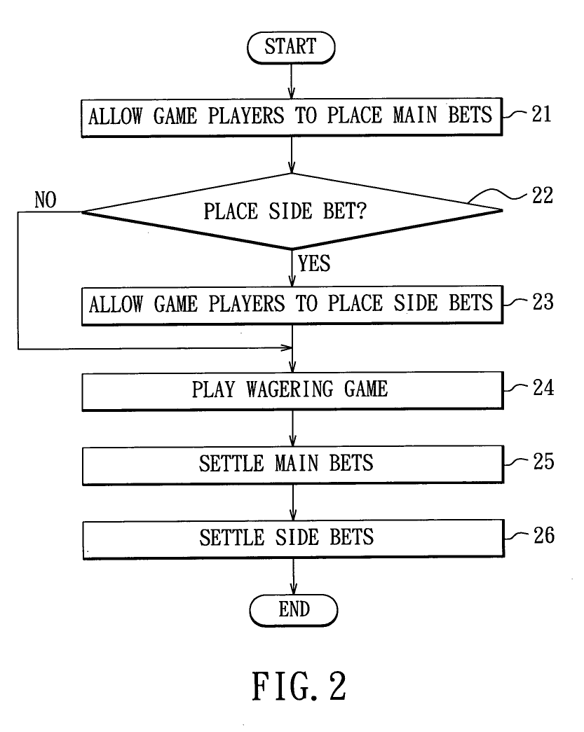

FIG. 2 is a flowchart of the preferred embodiment of a multi-player gaming method according to the present invention. The gaming method is to be implemented using a multi-player gaming system 3, as best shown in FIG. 3. The multi-player gaming system 3 includes a plurality of player terminals 31 to 35, each of which is to be operated by a game player, and a host terminal 30 connected to the player terminals 31 to 35. In this embodiment, there are five player terminals 31 to 35, although the number of the player terminals that are installed maybe varied depending on actual requirements. The host terminal 30 is operable so as to enable the game players to play a wagering game therewith. The host terminal 30 includes a big screen 300 to enable the game players to view the progress of the wagering game. Each of the player terminals 31 to 35 includes a screen 310 to 350 for message interaction with the host terminal 30, and an operating panel having a set of operating members, such as control keys, joysticks, etc., mounted thereon.

The gaming system 3 of this embodiment has a hardware configuration similar to that of the conventional gaming system 1 described hereinbefore. However, unlike the aforementioned conventional gaming system 1, the gaming system 3 is loaded with a proprietary computer program product for implementing the gaming method of this invention. The preferred embodiment of the gaming method of this invention includes the steps shown in FIG. 2.

Initially, upon power on, the gaming system 3 is in a waiting state, and each game player operates the respective player terminal 31 to 35 to open a respective account with the gaming system 3 (such with the use of a prepaid account or game card) and to request the host terminal 30 to start a wagering game. Before starting the wagering game, the flow proceeds to step 21, where the host terminal 30 allows the game player of each of the player terminals 31 to 35 to place a main bet for the wagering game with the host terminal 30. The flow then proceeds to step 22, where the host terminal 30 gives the game player of each of the player terminals 31 to 35 an option to place a side bet for the wagering game with the game players of the other player terminals 31 to 35. If none of the game players wishes to place the respective side bet, the flow proceeds to step 24. Otherwise, the flow proceeds to step 23, where the game players who wish to place the respective side bet are allowed to do so using the respective player terminal 31 to 35, and an indication of the game players (such as those using the player terminals 31,33, 35) who placed the respective side bet is shown by the host terminal 30 on the big screen 300. Playing of the wagering game is started in step 24. At the end of the wagering game, the flow proceeds to step 25, where, based on the outcome of the wagering game, the host terminal 30 settles the main bets placed with the host terminal 30 according to predetermined first winning criteria. In this step, the host terminal 30 determines winning and losing game players according to the first winning criteria based on the outcome of the wagering game, pays off the main bets placed by the winning game players, and collects the main bets placed by the losing game players. The flow then ends for the game players (such as those using the player terminals 32, 34) who did not place the respective side bet. For the game players (such as those using the player terminals 31, 33, 35) who placed the respective side bet, the flow proceeds to step 26, where, based on the outcome of the wagering game, the host terminal 30 settles the side bets among the game players of the player terminals 31 to 35 who placed the respective side bet according to predetermined second winning criteria. In this step, the host terminal 30 determines winning and losing game players according to the second winning criteria based on the outcome of the wagering game, collects the side bets placed by the losing game players, and awards the collected side bets to the winning game player.

In one preferred implementation of the gaming system 3 of this invention, the wagering game is a racing game, such as a horse racing game. According to the first winning criteria, a winning game player is one who placed the main bet on a participant of the racing game that finished first (i.e., the fastest participant of the racing game). Therefore, in step 25, only those main bets that were placed on the fastest participant of the racing game are paid off by the host terminal 30, and the main bets that were placed on losing participants of the racing game are collected by the host terminal 30. In addition, according to the second winning criteria, a winning game player is one who placed the respective side bet on a participant of the racing game that finished last (i.e., the slowest participant of the racing game). Hence, in step 26, the host terminal 30 collects the side bets that were not placed on the slowest participant of the racing game, and awards the collected side bets to the winning game player who placed the respective side bet on the slowest participant of the racing game.

In another preferred implementation of the gaming system 3 of this invention, the wagering game is a card game. According to the first winning criteria, a winning game player is one who was dealt with a card hand better than that held by the host terminal 30. The first winning criteria can be similar to that commonly employed in a game of blackjack. Therefore, in step 25, only those main bets that were placed by the winning game players are paid off by the host terminal 30, and the main bets that were placed by the losing game players are collected by the host terminal 30. In addition, according to the second winning criteria, a winning game player is one who placed the respective side bet and was dealt with a card hand that is associated with a best face value relative to the card hands of the other game players who also placed the respective side bet. The criteria for determining the best face value among the card hands can be similar to those employed in other card games, such as baccarat. Hence, in step 26, the host terminal 30 collects the side bets that were not placed by the winning game player (i.e., the game player who placed the respective side bet and was dealt with the card hand having the best face value), and awards the collected side bets to the winning game player. For instance, if the game players using the player terminals 31, 33, 35 placed the respective side bet, and the game player using the player terminal 33 was dealt with the card hand having the best face value in a game of baccarat with respect to those of the game players using the other player terminals 31, 35, the side bets of the game players using the player terminals 31, 35 will be collected by the host terminal 30 and awarded to the game player using the player terminal 33.

If a game player does not wish to continue playing, the game player operates the respective player terminal 31 to 35 to send an end game request message to the host terminal 30. The host terminal 30, upon receiving the end game request message, updates the account data in the game player's account or game card before permitting the game player to retrieve his account or game card.

In sum, the multi-player gaming method and system of this invention not only allows game players to play a wagering game with the gaming system in a conventional manner, but also allows the game players to place side bets among themselves. As a result, player interest and excitement are improved in view of the inclusion of inter-player interaction as compared to the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A multi-player gaming method to be implemented using a gaming system that includes a plurality of player terminals, each of which is to be operated by a game player, and a host terminal connected to the player terminals and operable so as to enable the game players to play a wagering game therewith, said multi-player gaming method comprising the steps of:
a) configuring the host terminal to allow the game player of each of the player terminals to place a main bet for the wagering game with the host terminal, and an optional side bet for the wagering game with the game players of the other player terminals; and
b) based on an outcome of the wagering game, configuring the host terminal to settle the main bets placed with the host terminal according to predetermined first winning criteria, and to settle the side bets among the game players of the player terminals who placed a respective side bet according to predetermined second winning criteria.

2. The multi-player gaming method of claim 1, wherein in step b), the host terminal is configured to
determine winning and losing game players according to the first winning criteria based on the outcome of the wagering game,
pay off the main bets placed by the winning game players, and
collect the main bets placed by the losing game players.

3. The multi-player gaming method of claim 1, wherein in step b), the host terminal is configured to
determine winning and losing game players according to the second winning criteria based on the outcome of the wagering game,
collect the side bets placed by the losing game players, and
award the collected side bets to the winning game player.

4. The multi-player gaming method of claim 1, wherein the wagering game is a racing game.

5. The multi-player gaming method of claim 4, wherein the racing game is a horse racing game.

6. The multi-player gaming method of claim 4, wherein, according to the first winning criteria, a winning game player is one who placed the main bet on a participant of the racing game that finished first.

7. The multi-player gaming method of claim 4, wherein, according to the second winning criteria, a winning game player is one who placed the respective side bet on a participant of the racing game that finished last.

8. The multi-player gaming method of claim 1, wherein the wagering game is a card game.

9. The multi-player gaming method of claim 8, wherein, according to the first winning criteria, a winning game player is one who was dealt with a card hand better than that held by the host terminal.

10. The multi-player gaming method of claim 8, wherein, according to the second winning criteria, a winning game player is one who placed the respective side bet and was dealt with a card hand that is associated with a best face value relative to the card hands of the other game players who also placed the respective side bet.

11. A multi-player gaming system, comprising:
a plurality of player terminals adapted for operation by game players, respectively; and
a host terminal connected to said player terminals and operable so as to enable the game players to play a wagering game therewith;
wherein said host terminal is configured to allow the game player of each of said player terminals to place a main bet for the wagering game with said host terminal, and an optional side bet for the wagering game with the game players of other ones of said player terminals; and
wherein, based on an outcome of the wagering game, said host terminal is configured to settle the main bets placed with said host terminal according to predetermined first winning criteria, and to settle the side bets among the game players of said player terminals who placed a respective side bet according to predetermined second winning criteria.

12. The multi-player gaming system of claim 1, wherein said host terminal is configured to
determine winning and losing game players according to the first winning criteria based on the outcome of the wagering game,
pay off the main bets placed by the winning game players, and
collect the main bets placed by the losing game players.

13. The multi-player gaming system of claim 11, wherein said host terminal is configured to
determine winning and losing game players according to the second winning criteria based on the outcome of the wagering game,
collect the side bets placed by the losing game players, and
award the collected side bets to the winning game player.

14. The multi-player gaming system of claim 11, wherein the wagering game is a racing game.

15. The multi-player gaming system of claim 14, wherein the racing game is a horse racing game.

16. The multi-player gaming system of claim 14, wherein, according to the first winning criteria, a winning game player is one who placed the main bet on a participant of the racing game that finished first.

17. The multi-player gaming system of claim 14, wherein, according to the second winning criteria, a winning game player is one who placed the respective side bet on a participant of the racing game that finished last.

18. The multi-player gaming system of claim 11, wherein the wagering game is a card game.

19. The multi-player gaming system of claim 18, wherein, according to the first winning criteria, a winning game player is one who was dealt with a card hand better than that held by the host terminal.

20. The multi-player gaming system of claim 18, wherein, according to the second winning criteria, a winning game player is one who placed the respective side bet and was dealt with a card hand that is associated with a best face value relative to the card hands of the other game players who also placed the respective side bet.
